(19) United States
(12) Patent Application Publication
(10) Pub. No.: US 2026/0106936 A1
(43) Pub. Date: Apr. 16, 2026

(54) ARTIFICIAL INTELLIGENCE DRIVEN EMERGENCY ALERT SYSTEM

(71) Applicant: T-Mobile Innovations LLC, Overland Park, KS (US)

(72) Inventor: Sathyaraj KOLANDASAMY, Prosper, TX (US)

(21) Appl. No.: 18/915,747

(22) Filed: Oct. 15, 2024

(51) Int. Cl. H04M 3/51; H04M 3/42; H04W 4/12

(52) U.S. Cl. CPC H04M 3/5116; H04M 3/42348; H04W 4/12; H04M 2242/04

(57) ABSTRACT

Systems and methods are provided for artificial intelligence (AI) driven emergency alerts. A system utilizes AI for emergency call handling and routing of emergency services. The system further utilizes AI for performing audio and video analysis. The system also enables AI driven predictive analysis, alert dissemination, and resource allocation to improve the existing emergency response infrastructure.

### TECHNICAL BACKGROUND

The current infrastructure for routing emergency calls suffers from various deficiencies. Emergency events, such as shootings, fires, floods, storms, and others can wreak havoc on infrastructure. The events can cause roads to close, create traffic backups, and endanger the lives and well-being of those entering the area impacted by the emergency event. Further, such events can pose increasing danger when emergency personnel are unable to reach the impacted areas due to imperfect call routing that may occur due to lack of awareness of the impacted location.

The current enhanced 911 (E911) system faces several issues that can impact its efficiency and effectiveness. Emergency calls can sometimes be routed to the wrong and Public Safety Answering Point (PSAP), especially near jurisdictional boundaries, causing delays in emergency responses. Additionally, during large-scale emergencies or disasters, PSAPs can become overwhelmed with high call volumes, leading to longer wait times and delayed responses.

A further issue arises with location accuracy. Emergency calls are often routed based on location information provided by the emergency caller. Accordingly, the process of identifying a caller location is manual and cumbersome. The reliance on manual processes for information entry and dispatching can introduce errors and delays. Current systems often lack the ability to integrate real-time data from additional sources and further lack predictive analytics that would help to anticipate and prepare for potential emergencies. Therefore, without these features, current emergency call centers often display suboptimal allocation and dispatching of emergency resources, which leads to delayed responses from emergency responders.

With the omni-presence of wireless devices, a wireless network, such as a cellular network can be utilized to spread information about emergency events. Wireless networks can include an access node (e.g., base station) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)) and 6G RATs. Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs

Accordingly, a need exists for leveraging and improving upon the existing wireless infrastructure to spread awareness and improve emergency response times.

### OVERVIEW

Exemplary embodiments described herein include systems, methods, and processing nodes for using artificial intelligence (AI) to enhance emergency calling infrastructure. An exemplary method includes performing audio analysis using artificial intelligence (AI) on an incoming emergency call from a wireless device to detect an incident in a vicinity of an emergency caller utilizing the wireless device. The method further includes utilizing enhanced location services to supplement global positioning system (GPS) data from the wireless device to precisely locate the emergency caller. Further, the method includes selecting a public safety answering point (PSAP) based on the enhanced location services and routing the emergency call to the selected PSAP with any detected incident from the audio analysis.

A further exemplary embodiment includes an artificial intelligence (AI) driven emergency alert system. The system includes a communication interface receiving emergency calls and captured data including video surveillance data from a coverage area. The system additionally includes a memory storing data and instructions and a processor executing the stored instructions using the captured data to perform multiple operations. The operations include analyzing the video surveillance data to identify emergencies within the coverage area. The operations further include performing audio analysis on an incoming emergency call from a wireless device to detect an incident in a vicinity of an emergency caller utilizing the wireless device. The operations further include triggering real-time alerts based on the video surveillance analysis and the audio analysis.

In further embodiments, a method includes performing audio analysis using artificial intelligence (AI) on an incoming emergency call from a wireless device to detect an incident in a vicinity of an emergency caller utilizing the wireless device. The method further includes analyzing video surveillance data collected within a coverage area to identify emergencies within the coverage area and triggering real-time alerts to wireless devices within the coverage area based on the video surveillance and audio analysis.

In yet a further exemplary embodiment, a non-transitory computer readable medium is provided. The non-transitory computer-readable medium stores instructions executed by a processor to perform the multiple operations described above.

### BRIEF DESCRIPTION OF THE DRAWINGS

FIG. 1 depicts an exemplary operating environment for an AI driven emergency alert system in accordance with the disclosed embodiments.

FIG. 2 illustrates an additional exemplary operating environment for an AI driven emergency alert system in accordance with disclosed embodiments.

FIG. 3 illustrates an exemplary configuration for an AI driven emergency alert system in accordance with disclosed embodiments.

FIG. 4 depicts an exemplary access node in accordance with disclosed embodiments.

FIG. 5 depicts an exemplary method for operating an AI driven emergency alert system in accordance with disclosed embodiments.

FIG. 6 depicts a further exemplary method for operating an AI driven emergency alert system in accordance with disclosed embodiments.

### DETAILED DESCRIPTION

Exemplary embodiments described herein include systems and methods for an AI driven emergency alert system. In embodiments provided herein, the emergency event may be one of or a combination of multiple types of events, such as, for example, home invasions, medical emergencies, robberies, assaults, fires, active shooting scenarios, natural disasters, vehicle collisions or crashes or other road blockages, plane crashes, etc. Natural disasters may include, for example, floods, wildfires, hurricanes, tornados, etc.

Various types of sensors and detectors, such as for example Internet of Things (IoT) devices may be included in or may communicate with the system described herein in order to detect these emergency events. Current systems often lack the ability to integrate real-time data from sources other than a dialog with an emergency caller. Various sources, such as video feeds, sensor data, or social media may provide valuable situational awareness.

Further, currently implemented systems often result in a significant delay from the time an emergency call is completed to the time an emergency responder is dispatched. Often, the delay results from the use of a manual process driven by human involvement. Upon making an emergency call, a caller is first routed to the emergency call center. A caller location must be determined before the human dispatcher routes the call to a PSAP. For landlines and IP calls from laptops, a database is typically consulted that includes an E911 address. For mobile phones, GPS coordinates determined by the wireless network may be implemented to determine location. Based on this location, the call is routed to PSAP. A human dispatcher at the PSAP determines appropriate emergency services.

In embodiments provided herein, automated systems and processes can be utilized to integrate additional information for emergency response handling. For example, audio analysis logic can be utilized to analyze audio during emergency calls in order to ascertain additional information such as an emergency incident. For example, background noises can be incorporated to determine a type of emergency. Further background voices can be utilized to capture additional information. A natural language processor (NLP) may be incorporated to analyze audio and provide automated language translation.

Additionally, the AI driven emergency alert system can analyze captured video to detect incidents that result in a need for emergency response. For example, the captured video may originate from public locations where video is available, such as from traffic cameras or other types of surveillance cameras. Further, private businesses or individuals may voluntarily share video and/or audio feed from exterior cameras. Further, it should be noted that various types of sensors could be utilized in order to sense the emergency events. For example, the sensors may be acoustical detectors, cameras, heat sensors, smoke sensors, or other types of sensors. The sensors may be independently located or may be integrated with an access node or other portion of a wireless network. This collected and analyzed information could be routed from the emergency calling center to the PSAP along with the emergency call.

Further, the AI driven emergency alert system may enhance previously existing location data such as E-911 addresses and GPS data with WiFi data, Bluetooth data or other data from cellular networks in order to locate an emergency caller more precisely. AI can improve location accuracy through advanced algorithms that combine GPS, Wi-Fi, and cellular data. Further, the AI driven system described herein can reduce misrouting by intelligently routing calls to the correct PSAP based on the integration and analysis of real-time data from various sources to better identify callers and their locations.

Upgrading to AI driven systems can enhance interoperability and reduce reliance on outdated infrastructure. AI can assist in triaging calls, prioritizing emergencies, and filtering out non-emergency calls. Embodiments described herein can integrate and analyze real-time data from multiple sources, providing a comprehensive view of emergency situations. Further, the AI driven system described herein can help in predicting high-risk areas and times, allowing for better resource allocation and preparedness. Additionally, the analysis can be utilized to generate alerts in order to make wireless devices in an impacted area aware of an emergency situation.

Accordingly, in embodiments provided herein, an AI driven emergency alert system leverages artificial intelligence to enhance the traditional emergency response framework. Proposed embodiments are designed to automatically provide emergency responders with location information and incident information when an emergency call is made in order to improve the speed and accuracy of emergency response.

In embodiments described herein, processing tasks may be performed at a processing node connected to an emergency alert system, a core network or closer to the cellular customer in order to respond to emergencies more quickly. For example, embodiments disclosed herein may be implemented the cellular base stations or other edge nodes. Through the use of systems, methods, and devices described herein, emergency response systems can be updated automatically in response to emergency event detection procedures.

In addition to the systems and methods described herein, the operations for providing an enhanced emergency alert system may be implemented as computer-readable instructions or methods, and processing nodes on the network for executing the instructions or methods. The processing node may include a processor included in the access node or a processor included in any controller node in the wireless network that is coupled to the access node.

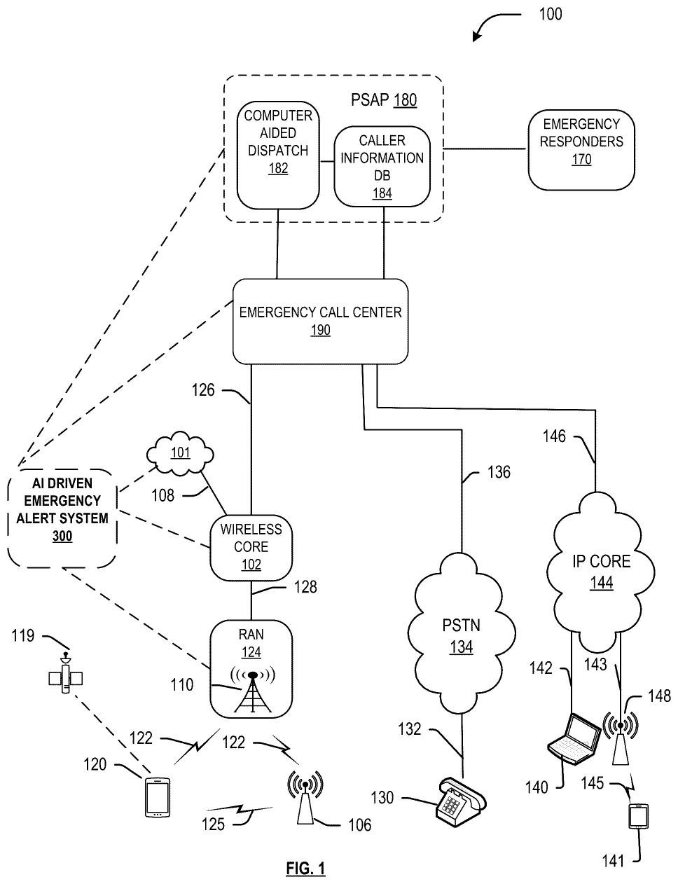

FIG. 1 depicts an exemplary environment 100 for utilizing an AI driven emergency alert system 300 in accordance with the disclosed embodiments. The AI driven emergency alert system 300 may communicate with or be incorporated in an emergency call center 190 and a PSAP 180. The emergency call center 190 ensures that emergency calls are transmitted to a PSAP 180. The PSAP 180 is responsible for dispatching emergency responders 170 to an emergency caller. Although only one PSAP 180 is shown, it should be understood that the emergency call center 190 may route calls to one of multiple PSAPs 180.

The emergency call center 190 may be a 911 call routing system including a switch or selective router that routes emergency calls to a selected PSAP 180. The selected PSAP 180 may include computer aided dispatch 182 and a caller information database (DB) 184. The computer aided dispatch 182 may route the emergency call to emergency responders 170 based on information from the AI driven emergency alert system 300, the emergency call center 190, and the caller information database 184.

The environment 100 may include multiple devices communicating over different networks with the emergency call center 190. For example, a computing device 140 may make an IP call to the emergency calling center 190 through an IP core 144. A wireless device 141 may communicate over wireless link 143 with a WiFi gateway device 148 to make an IP emergency call through the IP core 144. The computing device 140, WiFi gateway device 148, and wireless device 141 may communicate using links 142, 143, and 146 with the emergency call center 190.

Additionally, a landline telephone 130 may communicate with the emergency call center 190. The landline telephone 130 may communicate using a public switched telephone network (PSTN) 134 over communication links 132 and 136.

Further, a wireless device 120 may communicate with the emergency call center 190. The wireless device 120 may access a communication network 101, wireless core network 102, and a radio access network (RAN) 124, including at least one access node 110. The core network 102 is connected to the communication network 101 over communication link 108. The RAN 124 may include other devices and additional access nodes. As will be further described below, the other devices may capture data for transmission to the AI driven emergency alert system 300. The wireless device 120 may be an end-user wireless device and may operate within one or more coverage areas and communicate with the RAN 124 over communication link 122, which may for example be a 5G NR and/or 4G LTE communication link. Further, the wireless device 120 may communicate with a wireless gateway device 106, which may include for example, a modem and router combination, over a wireless link 125. Additionally, satellite 119 may provide positioning information for the wireless device 120.

The environment 100 may further include the AI driven emergency alert system 300, which is illustrated as communicating with the emergency call center 190, the PSAP 180, the communication network 101, the core network 102, and the RAN 124. As an alternative, the AI driven emergency alert system 300 may be integrated with the emergency call center 190 and/or the PSAP 180. However, it should be noted that the AI driven emergency alert system 300 may be distributed. For example, the AI driven emergency alert system 300 may utilize components located at the core network 102 and at one or more multiple access nodes 110. Alternatively, the AI driven emergency alert system 300 may be an entirely discrete component, such as a processing node.

The AI driven emergency alert system 300 receives information pertaining to emergency events from various sources including wireless devices 120, 141, computing device 140, and landline telephone 130. The AI driven emergency alert system 300 may further receive information from cameras, sensors, or other devices within a coverage area. In some embodiments, sensors or cameras may be affixed to the access node 110 or to any access node within the system.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices. Wireless network protocols can comprise MBMS, code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), Fifth Generation mobile networks or wireless systems (5G, 5G New Radio (“5G NR”), or 5G LTE), and other wireless network protocols. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or other wired network protocols. Communication network 101 can also comprise additional base stations, controller nodes, telephony switches, internet routers, network gateways, computer systems, communication links, or some other type of communication equipment, and combinations thereof.

The core network 102 includes core network functions and elements. The core network 102 may have an evolved packet core (EPC) or may be structured using a service-based architecture (SBA). The network functions and elements may be separated into user plane functions and control plane functions. In an SBA architecture, service-based interfaces may be utilized between control-plane functions, while user-plane functions connect over point-to-point link. Although one core network 102 is shown, multiple core networks 102 may be utilized. Alternatively, the single core network 102 may include a distributed, cloud-native, converged core gateway. Thus, as an example, the converged core gateway could connect a 4G LTE evolved packet core (EPC) to a 5G core network.

Communication links 108, 126, 128, 132, 136, 142, 143, and 146 can use various communication media, such as air, space, metal, optical fiber, or some other signal propagation path, including combinations thereof. Communication links 108, 126, 128, 132, 136, 142, 143, and 146 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Other wireless protocols can also be used. Communication links 108, 126, 128, 132, 136, 142, 143, and 146 can be direct links or might include various equipment, intermediate components, systems, and networks, such as a cell site router, etc. Communication links 108, 126, 128, 132, 136, 142, 143, and 146 may comprise many different signals sharing the same link.

The RAN 124 may include various access network systems and devices such as access node 110. The RAN 124 is disposed between the core network 102 and the end-user wireless device 120. Components of the RAN 124 may communicate directly with the core network 102 and others may communicate directly with the end user wireless device 120. The RAN 124 may provide services from the core networks 102 to the end-user wireless device 120.

The RAN 124 includes at least an access node (or base station) 110 such as an eNodeB of gNodeB 110 communicating with the end-user wireless device 120. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB.

Access node 110 can be, for example, standard access nodes such as a macro-cell access node, a base transceiver station, a radio base station, an eNodeB device, an enhanced eNodeB device, a gNodeB in 5G New Radio (“5G NR”), or the like. The gNBs may include, for example, centralized units (CUs) and distributed units (DUs).

In additional embodiments, access nodes may comprise two co-located cells, or antenna/transceiver combinations that are mounted on the same structure. Alternatively, access node 110 may comprise a short range, low power, small-cell access node such as a microcell access node, a picocell access node, a femtocell access node, or a home eNodeB device. As will be further described below, functionality for AI driven emergency alerts may be included within the access nodes. Access node 110 can be configured to deploy one or more different carriers, utilizing one or more RATs. For example, a gNodeB may support NR and an eNodeB may provide LTE coverage. Any other combination of access nodes and carriers deployed therefrom may be evident to those having ordinary skill in the art in light of this disclosure.

The access nodes 110 can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Furthermore, in embodiments set forth herein, the access nodes 110 are able to interact with the AI driven emergency response system 300 for triggering emergency alerts.

The wireless devices 120 may include any wireless device included in a wireless network. For example, the term “wireless device” may include a relay node, which may communicate with an access node. The term “wireless device” may also include an end-user wireless device, which may communicate with the access node in the access network 124 through the relay node. The term “wireless device” may further include an end-user wireless device that communicates with the access node directly without being relayed by a relay node.

Wireless device 120 may be any device, system, combination of devices, or other such communication platform capable of communicating wirelessly with access network 110 using one or more frequency bands and wireless carriers deployed therefrom. The wireless device 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless device 120 may be or include high power wireless devices or standard power wireless devices. Other types of communication platforms are possible.

Environment 100 may further include many components not specifically shown in FIG. 1 including processing nodes, controller nodes, routers, gateways, and physical and/or wireless data links for communicating signals among various network elements. Environment 100 may include one or more of a local area network, a wide area network, and an internetwork (including the Internet). Communication system 100 may be capable of communicating signals and carrying data, for example, to support voice, push-to-talk, broadcast video, and data communications by end-user wireless devices 120. Environment 100 may include additional base stations, controller nodes, telephony switches, internet routers, network gateways, computer systems, communication links, or other type of communication equipment, and combinations thereof.

Other network elements may be present in the environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the access network 124 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes, including access nodes, controller nodes, and gateway nodes described herein.

The operations for the AI driven emergency alerts may be implemented as computer-readable instructions or methods, and processing nodes on the network for executing the instructions or methods. The processing node may include a processor included in the access node or a processor included in any controller node in the wireless network that is coupled to the access node.

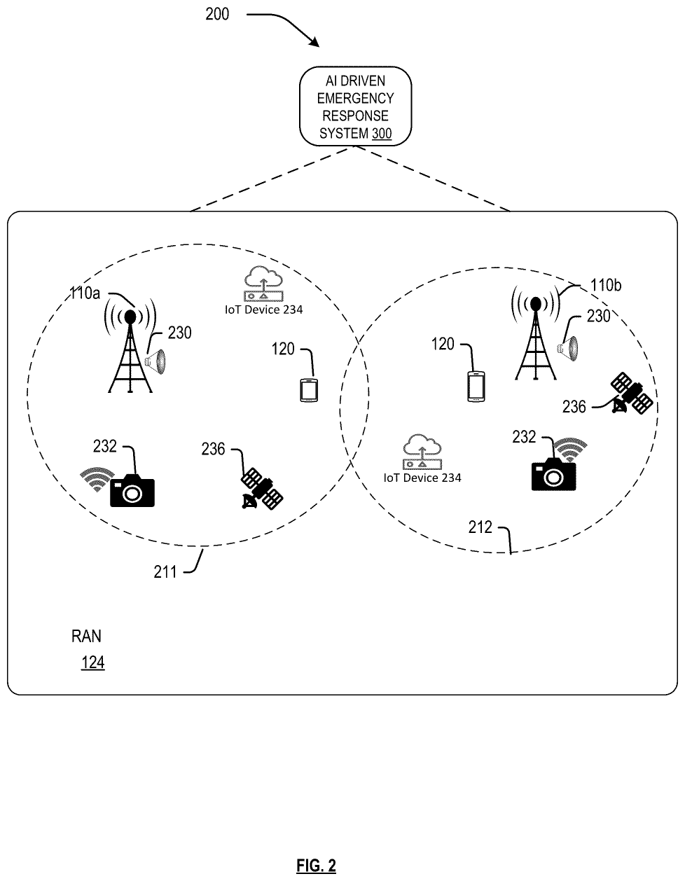

FIG. 2 depicts a further exemplary operating environment 200 for an AI driven emergency alert system 300 in accordance with the disclosed embodiments. The operating environment may include a RAN 124 including access nodes 110a and 110b, which may include a gNB and/or eNB. Multiple wireless devices 120 may communicate over the RAN 124. The wireless devices 120 may be end-user wireless devices and may operate within one or more coverage areas 211, 212 of the access nodes 110a and 110b. Further, satellites 236 may operate as GPS satellites for ascertaining coordinates of the wireless devices 120 as well as other devices within the coverage areas 211 and 212.

In addition to the wireless devices 120 and satellites 236, various types of sensors including acoustic sensors 230, video sensors or cameras 232, and Internet of Things (IoT sensors) 234 may communicate within the access nodes 110a and 110b within the RAN 124. The sensors 230, 232, and 234 may be considered to be part of the AI driven emergency alert system 300 or may be considered as separate components interacting with the AI driven emergency alert system 300. The sensors 230, 232, and 234 may be or include acoustic sensors, video sensors, heat sensors, flow sensors, weather sensors, smoke sensors, leak sensors, power sensors, or any other type of sensor. The video sensors 232 may include cameras capturing video or images within the coverage areas 211 and 212. Further, IoT devices 234 may capture additional types of data. The sensors 230, 232, 234 may be affixed to the access nodes 110a and 110b, which may be or include mobile network towers. The sensors 230, 232, and 234 however, be partially affixed, or may be strategically geographically dispersed in order to sense emergency incidents. The sensors 230, 232, and 234 may be or include sensor arrays encompassing an expansive geographical area.

While like reference numbers may refer to the elements described above with respect to FIG. 1, the environment 200 may include additional nodes similar to access nodes 110a and 110b. Further, these access nodes 110a and 110b may each operate within the same or different RATs. For example, coverage area 211 may be a 5G coverage area of access node 110a and coverage area 212 may be a 4G LTE coverage area of the access node 110b.

Infrastructure for performing the methods by supplying sensors 230, 232, and 234 may be available through schools, companies, churches, parks, city services, etc. In yet a further example, wildfire detection equipment uses a camera system or camera array 232 for detecting a wildfire. Danger could be assessed directly, such as when a fire is accurately present, and/or assessed based on the estimation of where a fire might be spreading utilizing AI, such as, for example machine learning (ML) or deep learning algorithms.

In yet another embodiment, the AI driven emergency alert system 300 combines a plurality of sensors, systems, and tools across a relatively large region. For example, weather related sensors may sense a hurricane, tsunami, tornado, etc. The sensors may be utilized by local governments, federal governments, private agencies and/or amateur agencies to estimate an impacted area The AI driven emergency alert system 300 may be a separate component that communicates with the access nodes 110a and 110b and may also communicate with the core network 102.

Further, the sensors 230, 232, and 234 may be dispersed in many locations, but may also be affixed to the access nodes 110a and 110b. In any case, the sensors 230, 232, and 234 are within a coverage area of the access nodes 110a and 110b and can transmit location data, which in some instances may be GPS coordinates, to the access nodes 110a and 110b. The notifications from the sensors 230, 232, and 234, may be received, for example, at a transceiver of the AI driven emergency alert system 300.

In some embodiments, the sensors 230, 232, and 234 may report their locations and information such as detected magnitudes related to an emergency incident to the AI driven emergency alert system 300. Additionally location of the sensors 230, 232, 234 may be stored or may be determined, for example by geo-location, triangulation, and receiving coordinates from GPS enabled wireless devices and sensors.

In some instances, sensors 230, 232, and 234 may send a notification including a GPS location and different magnitudes. For example, the notification may include GPS coordinates of the sensors and indication of magnitude, such as a temperature in case of a fire, or a water level in case of a flood, or a number of shots in case of a shooting. In some instances, two different sensor arrays may report different locations and magnitudes. The greater the reported magnitude of the event and the further apart the notifying sensors, the larger the impacted area may become.

For example, two sensors at different locations, such as IoT devices 234 may report water depth and their locations to the AI driven emergency alert system 300. Thus, the AI driven emergency alert system 300 utilizes a stored algorithm to determine an impacted area based on this received information. Similar information may be sent in the event of a fire. For example, heat sensors may report temperature in addition to their respective locations. In the case of a tornado, multiple sensors may report wind speed as well as their respective locations to the AI driven emergency alert system 300. The AI driven emergency alert system 300 may utilize this information to determine an impacted area.

The methods, systems, devices, networks, access nodes, and equipment described herein may be implemented with, contain, or be executed by one or more computer systems and/or processing nodes. The methods described above may also be stored on a non-transitory computer readable medium. Many of the elements of operating environments 100 or 200 may be, comprise, or include computers systems and/or processing nodes, including access nodes, controller nodes, and gateway nodes described herein.

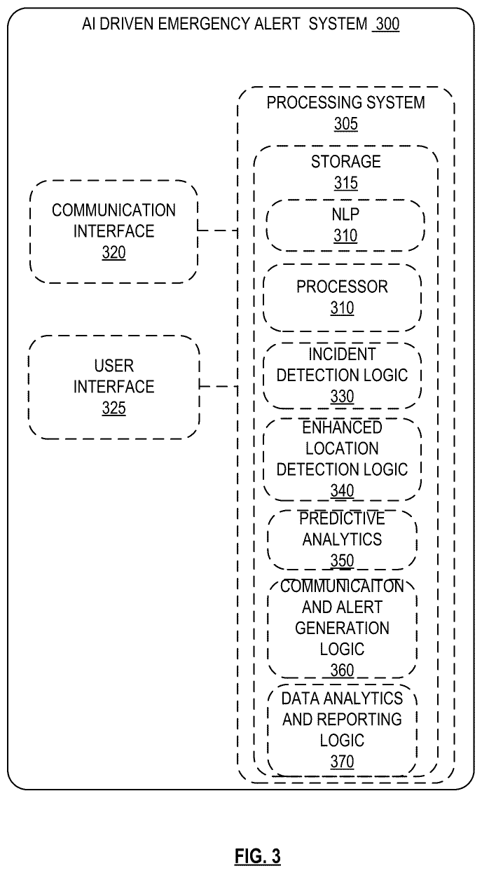

FIG. 3 depicts an AI driven emergency alert system 300, which may be configured to perform the methods and operations disclosed herein to enhance functionality of the emergency call center 190. In the disclosed embodiments, the AI driven emergency alert system 300 may be integrated with the access node 110, the core network 102, the emergency call center 190, or may be an entirely separate component, such as a processing node, capable of communicating with the access node 110, core network 102, the cameras 232, sensors 230, and IoT devices 234. In other embodiments, the AI driven emergency alert system 300 may be distributed so as to be functioning at multiple locations with the environment 100.

The AI driven emergency alert system 300 may be configured to enhance existing functionality using a processing system 305. Processing system 305 may include a processor 310 and a storage device 315. Storage device 315 may include a disk drive, a flash drive, a memory, or other storage device configured to store data and/or computer readable instructions or codes (e.g., software). The computer executable instructions or codes may be accessed and executed by processor 310 to perform various methods disclosed herein. Software stored in storage device 315 may include computer programs, firmware, or other form of machine-readable instructions, including an operating system, utilities, drivers, network interfaces, applications, or other type of software. For example, software stored in storage device 315 may include one or more modules for performing various operations described herein. For example, incident detection logic 330 may be provided to determine an emergency incident based on data provided by the above-described wireless devices 120, landline telephones 130, and computing devices 140 based on an emergency call. Incident detection logic 330 may further identify the occurrence of an emergency incident based on video feed from cameras 232, input from sensors 230, or IoT devices 234. Thus, the incident detection logic 330 may perform audio analysis, using AI to analyze the audio of incoming emergency calls, e.g., 911 calls, to detect critical incidents such as gunshots, explosions, or distress signals. Further, the incident detection logic 330 may utilize video surveillance by integrating AI with public and/or private video surveillance systems to identify emergencies such as car accidents, fires, or suspicious activities in real-time.

Audio analysis transforms and interprets audio signals recorded by digital devices, such as a wireless device 120. A variety of machine learning may be utilized including deep learning algorithms. In addition to using NLP for voice processing, environmental sound recognition can be utilized to identify noises in the environment. Audio analysis utilizes the time period, amplitude, and frequency among other data to analyze sounds captured by wireless device 120. The audio analysis utilizes the machine learning model and AI with the highest prediction accuracy to extract insights, sometimes inaudible to human beings, from speech, voices, environmental noise, industrial and traffic noise, background noise, and other types of acoustic signals.

The AI driven emergency alert system 300 may further include enhanced location detection logic 340. The enhanced location detection logic 340 may utilize advanced GPS tracking by implementing AI to improve the accuracy of GPS data from mobile phones or wireless devices 120, particularly in challenging environments such as dense urban areas. The enhanced location detection logic 340 may perform data fusion by combining data from multiple sources such as Wi-Fi, Bluetooth beacons, and cellular networks to pinpoint an emergency caller location.

The AI driven emergency alert system 300 may further include predictive analytics 350. The predictive analytics 350 may perform risk assessment by using historical data and real-time information to predict areas at higher risk of specific emergencies. The identification of areas at higher risk allows for preemptive measures. For example, predictive analytics 350 may allow for resource allocation to optimize deployment of emergency services based on predicted needs and availability of resources.

Real-time communication and alert generation logic 360 may include logic to send real-time alerts and updates to emergency responders and to the public based on the collected data through various channels. For example, the real-time communication and alert generation logic 360 may send real-time alerts and updates through channels such as text messaging, social media, and dedicated mobile applications. Further, the AI driven emergency alert system 300 may facilitate incident coordination by facilitating communication and coordination among different emergency response teams using the AI-driven logic described herein.

Additionally, the real-time communication and alert generation logic may include a natural language processor (NLP) for facilitating emergency caller interaction. The NLP may enhance interaction between dispatchers at the emergency call center 190 and callers through automated systems that understand and respond to natural language, ensuring critical information is quickly and accurately captured. Further, the NLP may provide multilingual support through real-time translation services to assist non-English speaking callers.

The AI driven emergency alert system 300 may additionally include data analytics and reporting logic 370. The data analytics and reporting logic 370 may be utilized to provide post-incident analysis. For example, the data analytics and reporting logic 370 may utilize AI to analyze incident data for patterns and trends, thereby helping to improve future response strategies. The data analytics and reporting logic may facilitate providing post-incident analysis. The post-incident analysis can be instrumental in modifying response strategies. The data analytics and reporting logic 370 may additionally provide system operators, such as emergency call center personnel with a real-time dashboard. The real-time dashboard offers decision makers, such as dispatchers, real-time insights into ongoing emergencies.

Processor 310 may be a microprocessor and may include hardware circuitry and/or embedded codes configured to retrieve and execute software stored in storage device 315. The AI driven emergency alert system 300 may include a communication interface 320 and a user interface 325. Communication interface 320 may be configured to enable the processing system 305 to communicate with other components, nodes, or devices in the wireless network. For example, the AI driven emergency alert system 300 can share intelligence with the access nodes 110.

Communication interface 320 may include hardware components, such as network communication ports, devices, routers, wires, antenna, transceivers, etc. These components may, for example, receive notifications of information captured pertaining to incident detection from the above-described components such as sensors 230, cameras 232, and IoT devices 234. User interface 325 may be configured to allow a user to provide input to the AI driven emergency alert system 300 and receive data or information from the AI driven emergency alert system 300. User interface 325 may include hardware components, such as touch screens, buttons, displays, speakers, etc. The AI driven emergency alert system 300 may further include other components such as a power management unit, a control interface unit, etc.

The AI driven emergency alert system 300 thus may utilize the memory 315 and the processor 310 to perform multiple operations. For example, the processor 310 may access stored instructions in the memory 315 to determine that an emergency event has occurred, determine the type of emergency event, determine the location of the emergency event, select a PSAP for responding to the emergency event, and send a notification with appended information to the selected PSAP.

The location of the AI driven emergency alert system 300 may depend upon the network architecture. For example, in smaller networks, a single AI driven emergency alert system 300 may be disposed for communication with wireless devices, sensors, cameras, IoT devices, and access nodes shown in FIGS. 1 and 2. However, in a larger network, multiple AI driven emergency alert systems 300 may be required to cover the network. Further, the functions of the AI driven emergency alert systems 300 may be split between the emergency call center 190, the core network 102, and the RAN 124.

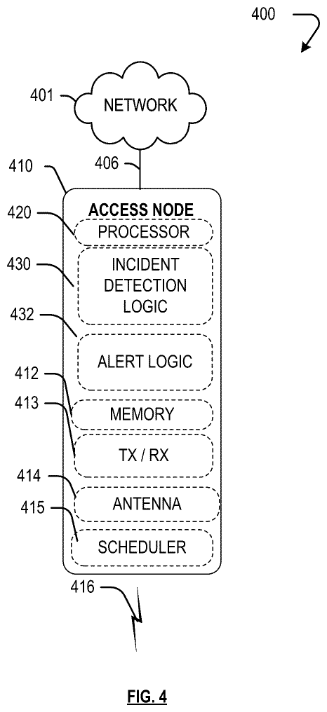

FIG. 4 illustrates an operating environment 400 for an exemplary access node 410 in accordance with the disclosed embodiments. In exemplary embodiments, the access node 410 is able to interact effectively with the AI driven emergency alert system 300 to capture data within a coverage area pertaining to emergency incidents and to report the captured data the AI driven emergency alert system 300. Further, the access node 410 may facilitate communication of alerts to devices within a coverage area 211 or 212.

The access node 410 can include, for example, a gNodeB or an eNodeB or a co-located eNB/gNB. Access node 410 may comprise, for example, a macro-cell access node, such as access node 110 described with reference to FIG. 1. Access node 410 is illustrated as comprising a processor 420, incident detection logic 430, alert logic 432, a memory 412, transceiver(s) 413, and antenna(s) 414. Processor 420 executes instructions stored on memory 412, while transceiver(s) 413 and antenna(s) 414 enable wireless communication with other network nodes, such as wireless devices 120 and other nodes. For example, wireless devices 120 may initiate uplink transmissions such that the transceivers 413 and antennas 414 receive messages from the wireless devices 120, sensors 230, cameras 232, and IoT devices 234, for example, over communication link 416. The transceivers 413 and antennas 414 may further pass the messages to a mobility entity in the core network. Further, the transceivers 413 and antennas 414 receive signals from the mobility entity in the core network 102, such as a mobility management entity (MME) or access and mobility function (AMF) and pass the messages to the appropriate wireless device or navigation system. Scheduler 415 may be provided for scheduling resources based on the presence and performance parameters of the wireless devices 120 as well as based on policies transmitted from the core network 102, 202. Network 401 may be similar to the network 101 discussed above with respect to FIG. 1.

In embodiments provided herein, processor 420 may operate in conjunction with scheduler 415 and incident detection logic 430 to ensure timely and accurate incident detection and communication of detected incidents to the AI driven emergency alert system 300. The alert logic 432 may further interact with the AI driven emergency alert system 300 to disseminate alerts to wireless devices 120. For example, alert logic 432 may receive instructions from the AI driven emergency alert system 300 or from the incident detection logic 430 to disseminate alerts to wireless devices 120, 141. The access node 410 may utilize transceivers 413 and antennas 414 to communicate information, for example with the wireless devices 120 and the AI driven emergency alert system 300. Further, while the incident detection logic 430 and alert logic 432 are illustrated as incorporated in the access node 410, these features may be disposed in the AI driven emergency alert system 300 or in other locations and may operate cooperatively with the AI driven emergency alert system 300.

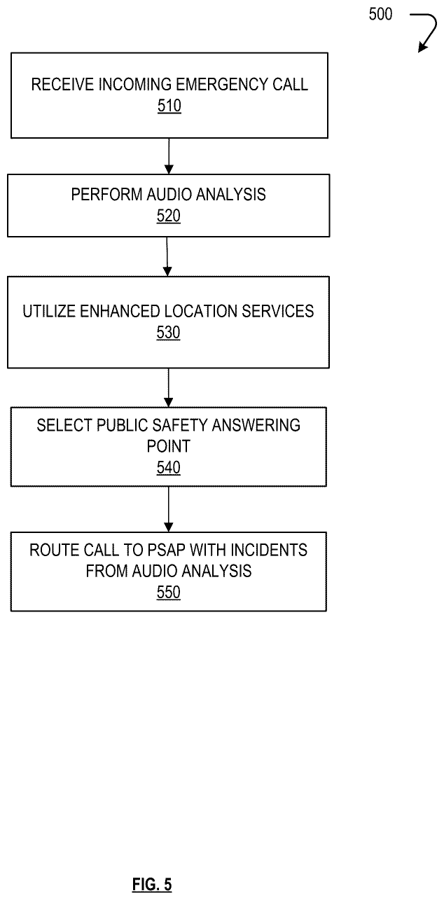

The disclosed methods for operating the AI driven emergency alert system 300 are discussed further below. FIG. 5 illustrates an exemplary method 500 for operating the AI driven emergency alert system 300 upon receipt of an emergency call. Method 500 may be performed by any suitable processor discussed herein, for example, the processor 310 included in the AI driven emergency alert system 300. For discussion purposes, as an example, method 500 is described as being performed by the processor 310 of the AI driven emergency alert system 300.

Method 500 begins in step 510, when the AI driven emergency alert system 300 receives an emergency call, such as a 911 call, from an emergency caller. It should be noted that the call may be received by the emergency call center 190, but also processed by the processor 310 of the AI driven emergency alert system 300.

In step 520, the processor 310 performs audio analysis of the emergency call to detect at least one incident in the vicinity of the emergency caller. The audio analysis may detect background noise and further may incorporate the NLP described above to assist the caller by providing automated language translation of communications during the emergency call when necessary.

Background noise detected through audio analysis may be indicative of an emergency incident, such as a shooting, a traffic accident, a home invasion, or other types of emergencies. Analysis of the dialog between the caller and the emergency dispatcher may further be utilized to characterize the emergency incident.

In step 530, the processor 310 may utilize enhanced location services to locate the emergency caller to an emergency caller location. In some instances, such as when the call originates at a landline 130, the enhanced location services are not necessary. However, when the call originates from a wireless device 120, 141, or computing device 140, enhanced location services may be helpful. The processor 310 may utilize the enhanced location detection logic 340, which uses advanced GPS tracking by implementing AI to improve the accuracy of GPS data from mobile phones, particularly in challenging environments such as dense urban areas. The enhanced location detection logic 340 may perform data fusion by combining data from multiple sources such as Wi-Fi, Bluetooth beacons, and cellular networks to pinpoint an emergency caller location. For example, when the wireless device used to make the emergency call is connected to a Wi-Fi access point, Wi-Fi based location or positioning may be used by the logic to determine the location of the Wi-Fi access point from a Wi-Fi access point location data store and derive an approximate location of the wireless device. In another example, the wireless device may receive location data from one or more Bluetooth beacons that the wireless device detects, such that the wireless device forwards the location data to the logic. In an additional example, cellular signal triangulation may be used by the system to determine an approximate location of the wireless device. Accordingly, the location data from the various sources may be combined by the logic using a data integration algorithm to derive a location of the wireless device and hence the emergency caller location.

In step 540, the processor 310 selects a PSAP based on the location of the emergency caller as determined in step 530. As illustrated in FIG. 1, the PSAP network 180 includes multiple PSAPs covering different areas. The caller location as determined in step 530 will be within an area covered by the selected PSAP 180 and the processor 310 will select the appropriate area.

Finally, in step 550, the processor 310 causes the emergency call to be routed to the selected PSAP. The emergency call will be routed to the selected PSAP along with the enhanced location information and the incident detection information from the audio analysis.

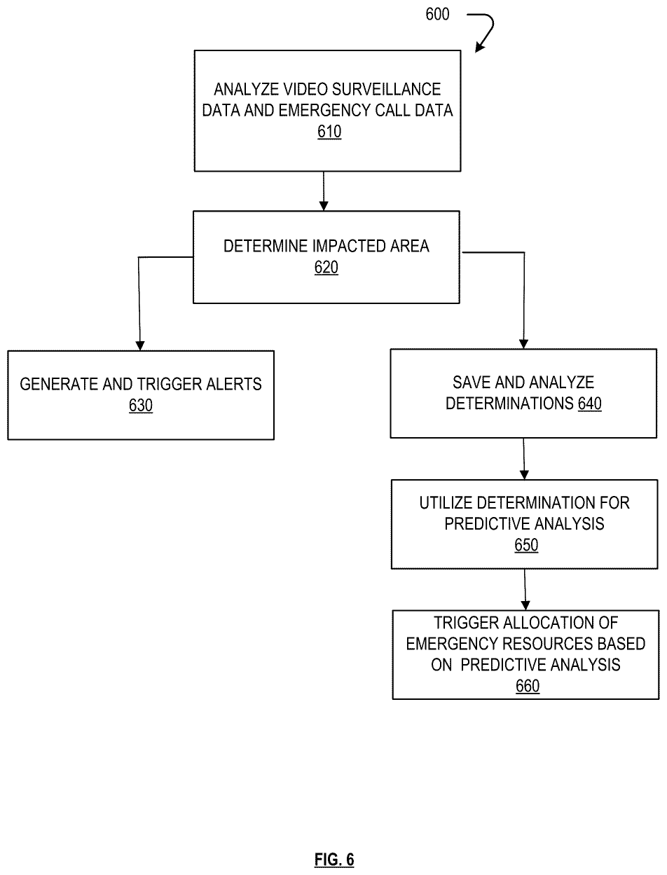

FIG. 6 illustrates a further exemplary method 600 for operation of the AI driven emergency alert system. Method 600 may be performed by any suitable processor discussed herein, for example, the processor 310 included in the AI driven emergency alert system 300. For discussion purposes, as an example, method 600 is described as being performed by the processor 310 of the AI driven emergency alert system 300.

Method 600 begins in step 610, with the analysis of surveillance data including video surveillance data, audio surveillance data, and other types of data that may be detected by sensors 230, cameras 232 and IoT devices 234 in the RAN 124. Step 610 may further include audio analysis and enhanced location data of received emergency calls.

In step 620, the processor 310 may determine an impacted area based on the analyzed data from the acoustic sensors 230, cameras 232 and/or IoT devices 234. The determination of the impacted area may also be based on the enhanced location analysis of the received emergency call. GPS coordinates, WiFi data, and cellular triangulation may be utilized. Based on stored algorithms accepting input including at least a sensor location and data indicating a magnitude related to a detected emergency incident, the AI driven emergency alert system 300 determines an impacted area. The impacted area may be defined by a geo-fence outlining the impacted area. Thus, in embodiments provided herein, the impacted area is determined based on data transmitted by the sensors 230, 232, 234 as well as GPS and cellular location data. Further, the impacted area may be determined through known triangulation procedures.

In step 630, based on the determination of the impacted area in step 620, the processor 310 may generate, trigger, and/or send alerts in step 630 based on collected surveillance data. As described above with reference to FIG. 4, the alerts may be delivered from an access node 410 in a wireless network. The alerts may be delivered to wireless devices 120, which may include wireless devices of emergency responders. The alerts may be delivered, for example, via a push notification to the wireless devices 120 or through a mobile application stored on the wireless devices 120. Further, alerts may be triggered from the AI driven emergency alert system 300 and may be delivered to the PSAPs within the PSAP network 180.

In step 640, the processor 310 may save and analyze determinations made in steps 610 and 620. This process may occur repeatedly over time to improve characterizations of emergencies and impacted areas using AI. Thus, the processor 310 may analyze the data to perform risk assessment in a coverage area using historical data and real-time information. to predict high risk locations within the coverage area.

Further, in step 650, the processor 310 may utilize the determinations for predictive analysis. The predictive analysis may, for example, predict the areas most likely to experience emergencies and may further predict the types of emergencies likely to be experienced in particular areas. For example, the processor 310 may predict high risk locations within the coverage areas 211 and 212.

Finally, in step 660, the processor 310 may trigger allocation of emergency resources based on the predictive analysis. Thus, the processor 310 may allocate allocating additional emergency resources to the high risk locations within the coverage area. For example, the area covered by one PSAP 180 may require more emergency response personnel than the area covered by another PSAP due to the detection of repeated wildfires in the area covered by PSAP 180 and the prediction that those wildfires are likely to occur with a higher frequency than in other areas.

In some embodiments, methods 500 and 600 may include additional or fewer steps or operations. Furthermore, the methods may include steps shown in each of the other methods. As one of ordinary skill in the art would understand, the methods 500 and 600 may be integrated in any useful manner. Further, the order of the steps shown is merely exemplary and the order of steps may be rearranged in any useful manner.

An AI driven emergency alert system has the potential to revolutionize emergency response by providing faster, more accurate, and more efficient services. The integration of AI technologies can help save lives, optimize resources, and enhance overall public safety.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
performing audio analysis using artificial intelligence (AI) on an incoming emergency call from a wireless device to detect one or more incidents in a vicinity of an emergency caller utilizing the wireless device;
utilizing enhanced location services to supplement global positioning system (GPS) data from the wireless device to precisely locate the emergency caller to an emergency caller location;
selecting a public safety answering point (PSAP) based on the emergency caller location provided by the enhanced location services; and
routing the emergency call to the selected PSAP with any detected incidents from the audio analysis.

2. The method of claim 1, further comprising implementing AI to analyze video surveillance data collected within a coverage area of an access node to identify one or more emergencies in the coverage area that are related to the incoming emergency call.

3. The method of claim 2, further comprising automatically generating and sending real-time alerts based on the collected surveillance data.

4. The method of claim 3, further comprising pushing the generated alerts to wireless devices.

5. The method of claim 3, further comprising sending an alert through a mobile application on the wireless device.

6. The method of claim 1, further comprising performing risk assessment for a coverage area of an access node using historical data and real-time information to predict high risk locations within the coverage area.

7. The method of claim 6, further comprising allocating additional emergency resources to the high risk locations within the coverage area.

8. The method of claim 1, further comprising utilizing natural language processing (NLP) to capture and analyze the incoming emergency call.

9. The method of claim 8, further comprising providing automated language translation of communications during the emergency call.

10. The method of claim 1, further comprising providing post-incident analysis using AI and utilizing the post-incident analysis to modify response strategies.

11. The method of claim 1, further comprising providing a system operator with a real-time dashboard providing real-time information pertaining to the one or more incidents.

12. An artificial intelligence (AI) driven emergency alert system comprising:
a communication interface receiving emergency calls and captured data including video surveillance data from a coverage area of an access node;
a memory storing data and instructions; and
a processor executing the stored instructions using the captured data to perform operations comprising;
analyzing the video surveillance data to identify emergencies within the coverage area; and
performing audio analysis on an incoming emergency call from a wireless device to detect one or more incidents in a vicinity of an emergency caller utilizing the wireless device; and
triggering real-time alerts based on the video surveillance analysis and the audio analysis.

13. The system of claim 12, wherein the operations further comprise utilizing enhanced location services to supplement global positioning system (GPS) data from the wireless device to precisely locate the emergency caller to an emergency caller location.

14. The system of claim 13, further comprising selecting a public safety answering point (PSAP) based on the emergency caller location provided by the enhanced location services.

15. The system of claim 14, further comprising routing the emergency call to the selected PSAP with any detected incidents from the audio analysis.

16. The system of claim 12, the operations further comprising performing risk assessment in a coverage area of the access node using historical data and real-time information to predict high risk locations within the coverage area.

17. A method comprising:
performing audio analysis using artificial intelligence (AI) on an incoming emergency call from a wireless device to detect one or more incidents in a vicinity of an emergency caller utilizing the wireless device;
analyzing video surveillance data collected within a coverage area of an access node to identify emergencies within the coverage area; and
triggering real-time alerts to wireless devices within the coverage area based on the video surveillance and the audio analysis.

18. The method of claim 17, further comprising utilizing enhanced location services to supplement global positioning system (GPS) data from the wireless device to precisely locate the emergency caller to an emergency caller location.

19. The method of claim 18, further comprising selecting a public safety answering point (PSAP) based on the emergency caller location provided by the enhanced location services.

20. The method of claim 19, further comprising routing the emergency call to the selected PSAP with any detected incidents from the audio analysis.
